(19) United States
(12) Patent Application Publication
(10) Pub. No.: US 2022/0327634 A1
(43) Pub. Date: Oct. 13, 2022

(54) GENERATING RELEVANT ATTRIBUTE DATA FOR BENCHMARK COMPARISON

(71) Applicant: INTUIT INC., Mountain View, CA (US)

(72) Inventors: Naveen NEELAKANDAN, Santa Clara, CA (US); Amit SETHIYA, Santa Clara, CA (US); Thomas LEE, Mountain View, CA (US)

(21) Appl. No.: 17/709,259

(22) Filed: Mar. 30, 2022

Related U.S. Application Data
(60) Provisional application No. 63/169,648, filed on Apr. 1, 2021.

(51) Int. Cl. G06Q 40/00; G06Q 10/06; G06F 16/29

(52) U.S. Cl. CPC G06Q 40/12; G06Q 10/06393; G06F 16/29

(57) ABSTRACT

Aspects of the present disclosure provide techniques for generating relevant attributes data for benchmark comparison based on geospatial boundaries. According to certain embodiments, based on a geospatial-based query using the coordinates of a company, a first group of companies is found within a first radius of the company. The first group of companies is further queried based on a financial metric within a range of the same metric of the company. If the query results in a statistically significant number of companies in the first group of companies, financial attributes of each of the first group of companies are aggregated to develop a benchmark. If the query results in too few companies, a second geospatial-based query is performed at a second radius greater than the first radius. Further iterations of geospatial-based queries are performed at increasing radii until a statistically significant number of companies is found to develop a benchmark.

### CROSS-REFERENCE TO RELATED APPLICATIONS

This application claims the benefit of and priority to U.S. Provisional Patent Application No. 63/169,648, filed on Apr. 1, 2021, the entire contents of which are incorporated herein by reference.

### INTRODUCTION

Aspects of the present disclosure relate to algorithmic filtering of entity attribute data, and more particularly to combining data filtering methods to generate data for entity attribute comparison using geospatial filtering.

While a company may have insight into how it is performing against internal operational and financial metrics, company leaders and advisors frequently look to other similarly situated peer companies for external benchmarks. Conventionally, companies rely on the knowledge of their financial advisors to identify peer companies as well as to know financial performance of those peer companies. In some cases, where peer companies are exceptionally large and publicly traded, some financial data may be available to advisors. However for smaller businesses, benchmarking against publicly traded companies doesn't provide a good measure, as the public company they are compared against likely is not in their geographical region, and likely has financial attributes far exceeding that of the small business.

Relying on the personal knowledge of financial advisors to understand peer companies in the region makes advice unreliable. Even if the advisor has extensive and broad knowledge of the particular industry of the small business, to be useful, this knowledge must be related to the geographical region of the small business. Moreover, the advisor would need detailed financial insights into the peer companies, such as revenue and expenses values, in addition to filtering these financial insights based on the financial attributes of the company she's advising, in order for the advice to be useful.

Business leaders conventionally rely on advisors because programmatically developing statistically relevant data sets to compare against company data can be daunting. Financial management tools lack broad data sets encompassing data of entities relevant to the company in question, computer resources required to filter this type of data at scale, and aggregated data views of entity data, all in real time.

What is needed are systems and methods to overcome the deficiencies of prior approaches.

### BRIEF SUMMARY

Certain embodiments provide methods and systems for generating relevant attribute data for benchmark comparison, based on geospatial boundaries. According to certain embodiments, based on a geospatial-based query using the coordinates of a company, a first group of companies is found within a first radius of the company. The first group of companies is further queried based on a financial metric within a range of the same metric of the company. If the query results in a statistically significant number of companies in the first group of companies, financial attributes of each of the first group of companies are aggregated to develop a benchmark. If the query results in too few companies, a second geospatial-based query is performed at a second radius greater than the first radius. Further iterations of geospatial-based queries are performed at increasing radii until a statistically significant number of companies is found to develop a benchmark.

A method according to certain embodiments is disclosed that includes receiving a first classification code and a base geospatial coordinate for a first company comprising a first company attribute in a range of company attribute values, generating a first geospatial boundary at a first distance from the base geospatial coordinate, the base geospatial coordinate being within the first geospatial boundary, and generating a first plurality of company data elements, each respective one of the first plurality of company data elements. The company data elements include a geospatial coordinate within the first geospatial boundary, a company attribute, and a second classification code that is substantially equal to the first classification code. The method further includes determining a number of company data elements that comprise the first plurality of company data elements, comparing the number of company data elements to a threshold, aggregating company attributes, and providing the aggregation of company attributes to a user via a user device.

A system according to certain embodiments is disclosed, that includes a memory comprising computer-readable instructions, and a processor configured to execute the computer-readable instructions. The computer-readable instructions cause the system to receive a first classification code and a base geospatial coordinate for a first company comprising a first company attribute in a range of company attribute values, generate a first geospatial boundary at a first distance from the base geospatial coordinate, the base geospatial coordinate being within the first geospatial boundary, and generate a first plurality of company data elements, each respective one of the first plurality of company data elements. The company data elements include a geospatial coordinate within the first geospatial boundary, a company attribute, and a second classification code that is substantially equal to the first classification code. The computer-readable instructions further cause the system to determine a number of company data elements that comprise the first plurality of company data elements, compare the number of company data elements to a threshold, aggregate company attributes, and provide the aggregation of company attributes to a user via a user device.

A method according to certain embodiments is disclosed that includes receiving a first company attribute in a first range, receiving a first company classification code, receiving a first company geospatial coordinate, and receiving, a plurality of second company data structures, each of the second company data structures comprising a second company geospatial coordinate and a second company attribute. The method further includes determining, a plurality of third company data structures based on the second company geospatial coordinate of each of the plurality of second company data structures, the plurality of third company data structures being a subset of the second company data structures, and displaying an aggregated value comprising the second company attribute of each of the plurality of third company data structures on a user device.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a system for generating relevant attribute data for benchmark comparison, according to certain embodiments.

FIG. 2 depicts an example method for generating relevant attribute data for benchmark comparison, according to certain embodiments.

FIG. 3 depicts an example view of iteratively increasing geospatial boundaries for determining geospatial based benchmarking, according to certain embodiments.

FIG. 4 depicts a method for generating relevant attribute data for benchmark comparison, according to certain embodiments.

FIG. 5 depicts a computing system for generating relevant attribute data for benchmark comparison, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for developing financial benchmarks for businesses based on geospatial boundaries. According to certain embodiments, based on a geospatial-based query using the coordinates of a company, a first group of companies is found within a first radius of the company. The first group of companies is further queried based on a financial metric within a range of the same metric of the company. If the query results in a threshold number of companies in the first group of companies, financial attributes of each of the first group of companies are aggregated to develop a benchmark. If the query results in too few companies, a second geospatial-based query is performed at a second radius greater than the first radius. Further iterations of geospatial-based queries are performed at increasing radii until a statistically significant number of companies is found to develop a benchmark. According to certain embodiments, company data in each radii are queried in parallel, returning the smallest radius that includes a sufficient number of companies, discussed below, to develop benchmark data for the company.

In developing benchmark metrics for a business, conventionally business owners have relied on the personal knowledge of financial advisors such as accountants to know about industry-relevant companies having similar financial attributes that are geographically relevant. In many cases, an individual financial advisor, or even team of financial advisors, may lack sufficient knowledge of enough companies to develop statistically meaningful benchmarks.

According to certain embodiments, a host application may be an application used by a plurality of businesses, which receives business attribute data from user businesses. Data from businesses includes transactions, revenue, expenses, and other business financial attributes. In the context of the current disclosure, any business data, attribute data, or the like is anonymized and scrubbed for personal identifying information of the businesses and individuals associated with the businesses. All data, data tables, and other stores of data of user businesses of the host application that may include business attributes are regularly ingested by a data lake where attributes are de-duplicated and stored in a format (e.g., in a JSON, XML, CSV, or other format) amendable to querying and analysis. As the host application is used by its users, the data lake is continually updated to reflect the updated and new data provided by users. In this context, continually updating can mean real time updates, or periodic updates per a given time period (e.g., each day, week, month).

A metrics generator application generates metrics data for each business having data in the data lake. According to certain embodiments, the metrics generator generates this metrics data periodically (e.g., daily, weekly, or over another time period) or continually, updating as the data lake receives updated and new data from the host application, to reflect the most current state of each business. This component computes metrics values such as, for example, net profit margin (NPM), gross profit margin (GPM), expenses, revenues, as well as statistical aggregate values for these values, such as mean and median values for individual companies. In certain embodiments metrics values may additionally be depicted as a time series, showing the metrics data for a given business over a time interval. The time-series values for each company are indexed by business industry classification, such as a NAICS code, and by location, which may include zip code, and geospatial coordinates such as latitude and longitude of a company, or that of a particular location of a company having multiple locations. The metrics generator ingests data from the data lake regularly to keep metrics data for each business up to date.

A benchmark service obtains metrics data from the metrics generator, and generates benchmark data for users of the host application. To obtain benchmarks for a business of a user, of the host application identifies her business, such as by using an NAICS code. The benchmark service will select metrics data from a number of other businesses having the same or similar NAICS code, for companies having similar revenue data to the user's business, in a relevant geospatial region to the user's business based on the geospatial coordinates of the user's business or zip code. The benchmark service will initially obtain metrics data from businesses within a first radius centered on the user's business. If there is insufficient benchmarking data within that radius, such as metrics data from less than a threshold number of other businesses, then the benchmarking service will iteratively increase the radius until the threshold number of businesses is achieved. According to certain embodiments, the threshold is the minimum number of businesses required to generate statistically significant benchmarking data for the requesting user's business. Because the benchmark service receives updated metrics data from the metrics generator application, a user requesting from the benchmark service receives aggregated benchmark data from relevant companies in real time, to compare her company to.

According to certain embodiments, benchmark data may be generated for entities that are not companies or businesses, such as families or individuals. In these embodiments, for example developing benchmark data for an individual, a transactional data value for the individual, such as net worth, income, budget related data and the like, is determined based on transactional data for the individual. Transactional data for other individuals within a range of that of the individual, that are within a given geospatial boundary relative to the individual, is determined in a manner that does not compromise the privacy or security of any individuals. The smallest geospatial boundary containing other individuals is chosen such that a significant number of other individuals are present in the boundary to provide meaningful benchmark data for the individual.

### Example System for Geospatial Based Industry Benchmarks

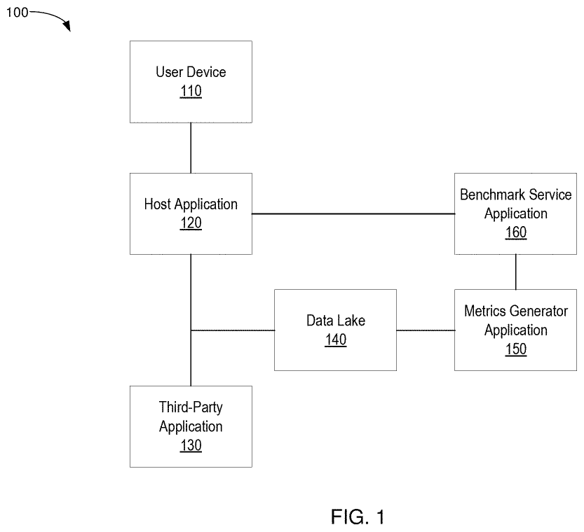

FIG. 1 depicts a system 100 for geospatial-based industry benchmarks, according to certain embodiments.

A user device 110 may be any device capable of sending and receiving information from a host application 120. According to certain embodiments, the user device 110 may be a mobile computing device such as a mobile phone or tablet, or a laptop computer, or devices such as a desktop computer not intended to be mobile. In certain embodiments, user device 110 may be smart television, a smart speaker, a smart thermostat, or other smart device capable of providing and receiving data in audio, visual, tactile, or other format.

The user device 110 is coupled to the host application 120 typically through a connection via a network connection that may be wired or wireless, or through a series of network connections. In certain embodiments, the user device could be directly connected to the host application. As would be appreciated by one of ordinary skill in the art there may be more than one user device 110 coupled to the host application 120.

The host application 120 may be a business management application such as QUICKBOOKS ONLINE™ from Intuit Inc., of Mountain View Calif., or other application capable of receiving data regarding company financial operations and organizing this information for company management. Host application 120 may be used by a plurality of users for management of their respective companies, as well as their financial advisors, such as for the preparation of taxes, reports, and development of advice for business owners. According to certain embodiments, a plurality of users provide company data regarding their businesses to the host application 120. Company data may include transactional data regarding business transactions and financial operations that in turn may be used to calculate company attributes for each business. In this context business transactions could be sales data, expense data, income data, cost data, and the like. Company data may further include hiring and payment of employees, marketing data, sales data, and the like. Moreover, as company data is provided by a user to the host application 120 as part of managing a business, new values for business data are provided over time, resulting in time series data for business data elements.

One or more components of the system 100 may be located on separate computer systems coupled together via a network or other communication system according to certain embodiments, while in others one or more may be located on the same computer system. The computer system(s) on which the components of system 100 are located may be physical computers, and/or virtual computers instantiated on a distributed computer system.

Company attributes that may be developed from company data include, for example, net profit margin, gross profit margin, and other business attributes that may be derived from business data. Additionally, company attributes include time series representations of company attributes.

In addition to financial data discussed above, company data further includes company geospatial coordinates and one or more company classification codes. The company geospatial coordinates may include a latitude and longitude for the location of the company. According to certain embodiments, the classification code(s) may be made up of a North American Industry Classification System (NAICS) code of up to 6 digits. In this context, classification codes may be substantially similar as between two companies if the first 4 digits of the NAICS code are the same.

According to certain embodiments, the system 100 further comprises a third-party application 130. The third-party application 130 may be a source of data to augment, or replace data provided by a user in the host application 120. For example, if the classification code is missing from the host application 120 for a given company, the third-party application may be queried for the missing classification code. In certain embodiments, if the classification code for a company provided by a user is different from the third-party application 130, the third-party application 130 classification code may be used in the host application 120. By way of example, the third-party application may be DUN & BRADSTREET™, provided by Dun & Bradstreet, Inc., or other third party application comprising classification code information for companies.

The system 100 further includes a data lake 140. According to certain embodiments, data lake 140 may be a database for storing company data from the host application 120 and may be a replica of data of the host application 120. Company data stored by the data lake 140 is continually updated from the host application 120. By way of example and not limitation, data stored in the data lake 140 may be stored in CSV, JSON. XML, TXT, RC, ORC, or other format capable of storing company data of the host application.

The system 100 further includes a metrics generator application 150 that receives company data from the data lake 140 and calculates metrics data for each company represented in the host application. Company data for each company in the host application aggregated to develop metrics data such as gross profit margin and net profit margin, and time series representations of these values. Other metrics data may be generated from company data, such as revenue, sales volume, profit per sale, expenses, cost of goods sold (COGS), Quick ratio, Current Ratio, accounts payable, accounts receivable, or any other company attribute and/or time series representation thereof that may be derived from company data. In addition to company attributes generated, each record containing company attributes additionally contains a geospatial location of the company based on one of geospatial coordinates, such as latitude and longitude and a zip code in which the company is located. Geospatial locations of companies may be used as a filtering mechanism, as will be discussed below.

In some embodiments, each record further includes, a revenue range indicator indicating a range in in which the company's revenue falls. Although there may be any number of revenue ranges, according to certain embodiments there are four ranges: <$100K, $100K-$500K, $500K-$1000K, and over $1000K. Revenue ranges of companies may be used as another filtering mechanism, as will be discussed below.

System 100 further includes a benchmark service application 160 that receives metrics data from the metrics generator application 150 and generates benchmarking data by aggregating the metrics data, which is communicated with the host application 120 to provide to the user. When a request is received for benchmarking data for a first company, say from a user device 110 coupled to host application 120, the benchmarking service application 160 obtains the geospatial location for the first company, the classification code for the first company, and the revenue for the first company.

Using metrics data from the metrics generator application 150, the benchmark service application 160 queries the metrics data based on the classification code of the first company. Metrics data for companies that have the same classification code, or in some embodiments substantially the same classification code, as the first company are returned and aggregated to form benchmarking data. The metrics data is further queried for companies within a first geospatial radius of the first company. In some embodiments the first radius is 10 miles, however, any value for the first radius may be chosen. The metrics data for companies in the first radius are queried against the revenue range of the first company, returning only metrics data for companies that are in the same revenue range as the first company. If there are a statistically significant number of companies returned in the revenue range of the company, metrics data, aggregated to form benchmarking data, is returned to the user device 110. In certain embodiments, a threshold is statistically significant number of companies, which is certain embodiments is 30; however, any value may be chosen for the threshold that is determined to be significant for a given application, benchmark, industry, or other factor.

If there are not enough companies returned such that the benchmarking data results are statistically significant, metrics data is queried at a second radius from the first company. In certain embodiments, the second radius (and subsequent radii) may be set at an offset value relative to the first radius that may be fixed or programmatically determined based on the threshold. According to certain embodiments the second radius is 20 miles. A query is run against the companies in the second radius, returning companies having revenue within the revenue range of the first company. The radius of the geospatial radius may be iteratively increased until the threshold number of companies is returned.

### Example Flow Diagram for Geospatial Based Industry Benchmarks

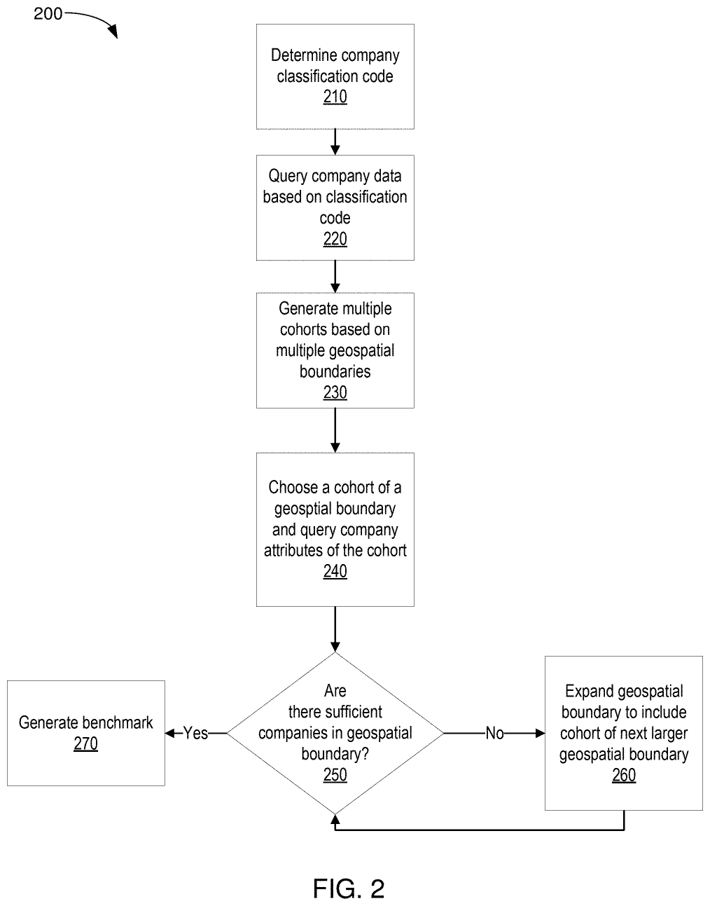

FIG. 2 depicts an example method 200 for geospatial industry benchmarks. A user, via a user device such as user device 100 of FIG. 1, requests benchmarking data for benchmarking a first company. According to certain embodiments, the request is provided to the host application 120.

At 210 the method determines a company classification code for the first company, which may be part of first company data resident in the hosting application 120, or received from a third-party application such as third party application 130 of FIG. 1.

As discussed above, company data from all companies having data at the host application 120, is stored in a data lake, such as data lake 140. The company data in the data lake is provided to metrics generator application 150, as discussed above, which generates metrics data for each company, and provides this company metrics data (including company geospatial and revenue range data) to the benchmark service application 160, that aggregates the metrics data to form benchmarking data.

At 220 the method queries the company data for companies having the same, or substantially similar, classification as the first company.

At 230 the method generates multiple cohorts of companies within multiple areas defined by increasing radii from the first company. In some embodiments, each increasing radius is 10 miles, however any increasing value, or formula to dynamically determine the value, may be utilized.

At 240, a cohort is chosen in a geospatial boundary is chosen, for example a first cohort of companies within a first geospatial boundary. The companies of the chosen cohort are queried against the revenue range of the first company revenue.

At 250 the method determines if there are sufficient companies in the cohort of the chosen geospatial boundary that have revenue data in the revenue range of the first company. According to certain embodiments, a sufficient number of companies meets or exceeds a threshold that indicates a statistically significant number of companies are present. In some embodiments the threshold number of companies is 30.

If the number of companies meets or exceeds the threshold, the method proceeds to 270, generating a benchmark for the first company comprised of benchmarking data from the companies of the chosen cohort(s).

If the number of companies is less than the threshold, at 260 the method expands the geospatial boundary to include an additional cohort of the next larger geospatial boundary, to be included with the first cohort of the first geospatial boundary.

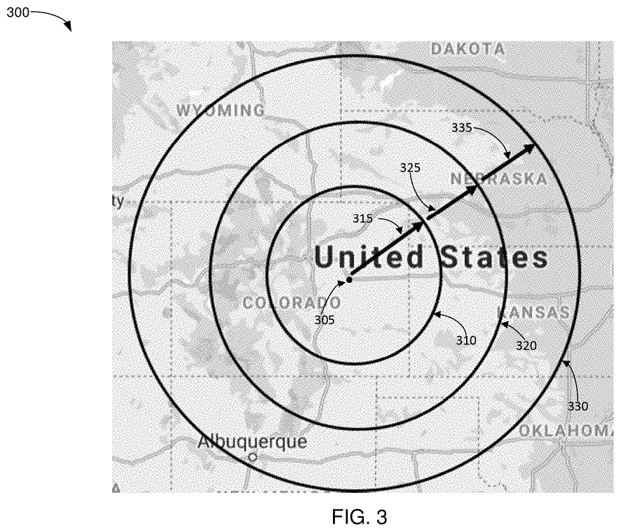

FIG. 3 depicts an example view 300 of iteratively increasing geospatial boundaries for determining geospatial based benchmarking, according to certain embodiments.

A first company for which benchmarking data is sought may be located at a first geospatial coordinate 305. After querying company data based on classification code, such as at 220 of FIG. 2, multiple cohorts of companies are developed based on one or more geospatial boundaries relative to the first geospatial coordinate 305. A first cohort, which may be the same as the first cohort discussed in connection with FIG. 2, may be located within a first geospatial boundary 310 that is a first radius 315 from the first geospatial coordinate 305.

If there are insufficient companies in the first cohort to meet a threshold number of companies, then a second cohort of companies encompassed by a second geospatial boundary 320 at a second radius 325 from the first geospatial coordinate is included in the data set.

If there are insufficient companies in the first and second cohorts to meet the threshold number of companies, then a third cohort of companies encompassed by a third geospatial boundary 330 at a third radius 335 from the first geospatial coordinate is included in the data set.

According to certain embodiments, additional cohorts may be added by iteratively defining additional geospatial boundaries at increasing radii from the first geospatial coordinate, until at least the threshold number of companies is in the data set. In some embodiments, the increasing radii may incremented with each iteration by a fixed value, for example, 10 miles. In other embodiments, one or more of the mdii may be determined by an algorithm, for example, to compensate for the exponentially increasing area represented by iteratively increasing areas.

Although the depicted geospatial boundaries are depicted by circles defined by radii, in certain embodiments other shape may be used, defined by parameters relevant to those shapes, attributes of the first company, attributes of companies in the various cohorts, or a combination of these.

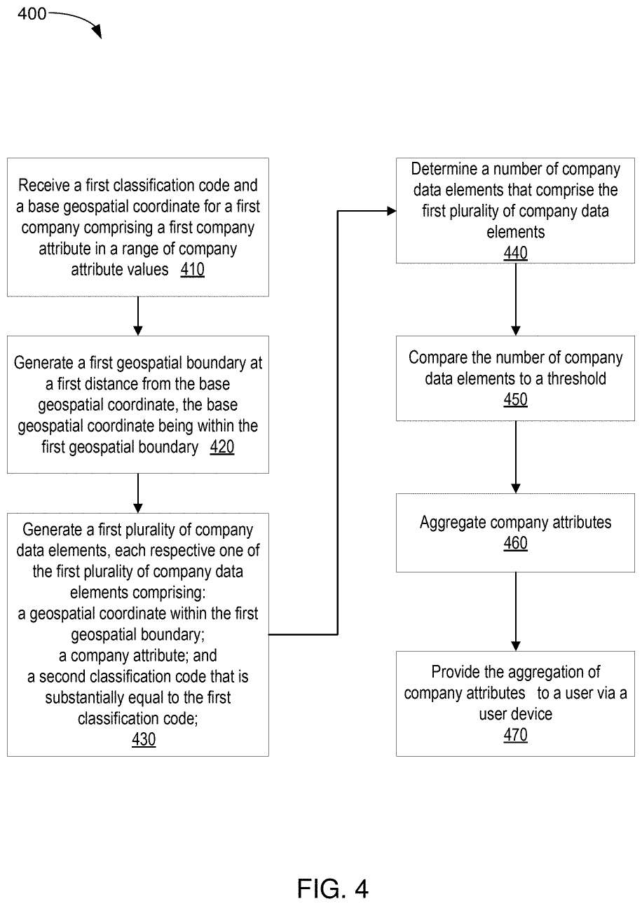

FIG. 4 depicts a method 400 for generating relevant attribute data for benchmark comparison, according to certain embodiments.

At 410, the method 400 receives a first classification code and a base geospatial coordinate for a first company comprising a first company attribute in a range of company attribute values.

At 420, a first geospatial boundary at a first distance from the base geospatial coordinate is generated, the base geospatial coordinate being within the first geospatial boundary.

At 430, the method 400 generates a first plurality of company data elements, each respective one of the first plurality of company data elements. According to certain embodiments, the company data elements include a geospatial coordinate within the first geospatial boundary, a company attribute, and a second classification code that is substantially equal to the first classification code.

At 440, the method 400 determines a number of company data elements that comprise the first plurality of company data elements, while at 450 the number of company data elements are compared to a threshold.

At 460, company attributes are aggregated.

At 470, the method 400 provides the aggregation of company attributes to a user via a user device. According to certain embodiments the aggregation of company values to a user includes displaying a statistical metric of the company values in a visual format and a confidence interval for the statistical compilation of company values.

In certain embodiments, the method 400 further includes generating a second geospatial boundary at a second distance from the base geospatial coordinate that is greater than the first distance. In further embodiments, the method 400 may include generating a second plurality of company data elements. In these embodiments, the second plurality of company data elements may include a geospatial coordinate within the second geospatial boundary and outside of the first geospatial boundary, a company attribute, and a third classification code that is substantially equal to the first classification code. In these embodiments, the first distance includes a first radius comprising the base geospatial coordinate as a center of the first radius, and the second distance includes a second radius comprising the base geospatial coordinate as a center of the second radius. According to further embodiments, the company attribute of the first plurality of company data elements and second plurality of company data elements are within the range of company attribute values.

According to certain embodiments, the method 400 may include determining that the number of company data elements comprising the first plurality of company data elements and second plurality of company data elements exceeds the threshold.

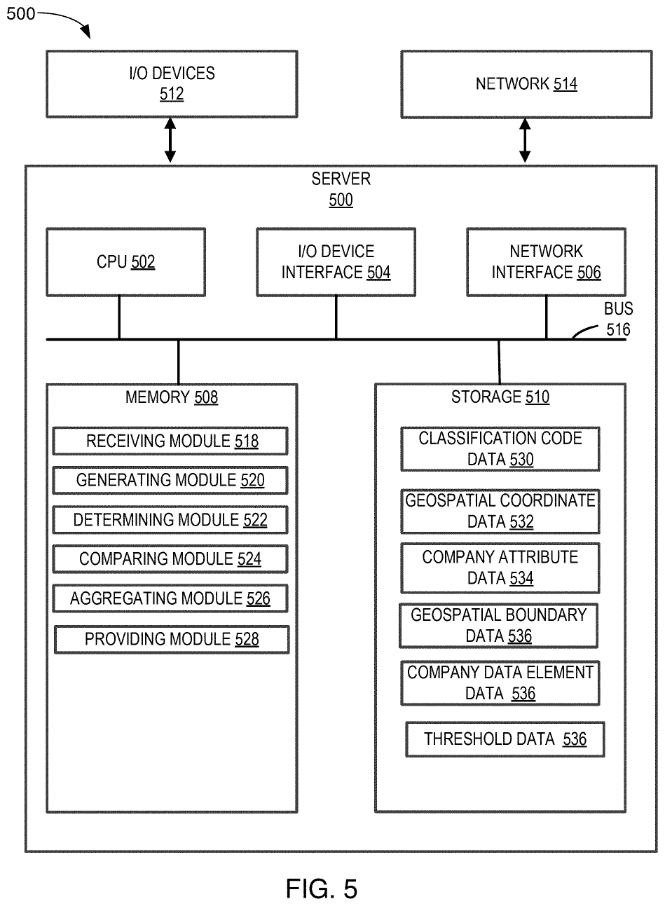

FIG. 5 depicts a computing system 500 for generating relevant attribute data for benchmark comparison according to certain embodiments, that may perform the methods described herein such as described with respect to FIGS. 1, 2, and 4.

Computing system 500 includes a central processing unit (CPU) 502 connected to a data bus 516. CPU 502 is configured to process computer-executable instructions, e.g., stored in memory 508 or storage 510, and to cause the computing system 500 to perform methods described herein, for example with respect to FIGS. 1, 2, and 4. CPU 502 is included to be representative of a single CPU, multiple CPUs, a single CPU having multiple processing cores, and other forms of processing architecture capable of executing computer-executable instructions.

Computing system 500 further includes input/output (I/O) device(s) 512 and interfaces 504, which allows computing system 500 to interface with input/output devices 512, such as, for example, keyboards, displays, mouse devices, pen input, and other devices that allow for interaction with computing system 500. Note that computing system 500 may connect with external I/O devices through physical and wireless connections (e.g., an external display device).

Computing system 500 further includes a network interface 506, which provides computing system 500 with access to external network 514 and thereby external computing devices.

Computing system 500 further includes memory 508, which in this example includes a receiving module 518, generating module 520, determining module 522, comparing module 524, aggregating module 526, and providing module 528 for performing operations described in FIGS. 1, 2, and 4.

Note that while shown as a single memory 508 in FIG. 5 for simplicity, the various aspects stored in memory 508 may be stored in different physical or virtual memories, including memories remote from computing system 500, but all accessible by CPU 502 via internal data connections such as bus 516 or a network 514.

Storage 510 further includes classification code data 530, geospatial coordinate data 532, company attribute data 534, geospatial boundary data 536, company data element data 536, and threshold data 536, as described in connection with FIGS. 1, 2, and 4.

While not depicted in FIG. 5, other aspects may be included in storage 510.

As with memory 508, a single storage 510 is depicted in FIG. 5 for simplicity, but various aspects stored in storage 510 may be stored in different physical or virtual storages, and all accessible to CPU 502 via internal data connections, such as bus 516, or external connection, such as network interfaces 506. One of skill in the art will appreciate that one or more elements of computing system 500 may be located remotely and accessed via a network 514.

### OTHER CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

Herein, reference is made to embodiments of the disclosure. However, it should be understood that the disclosure is not limited to specific described embodiments. Instead, any combination of features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the aspects, features, embodiments and advantages herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example. “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving a first classification code and a base geospatial coordinate for a first company;
generating a first geospatial boundary at a first distance from the base geospatial coordinate, the base geospatial coordinate being within the first geospatial boundary;
generating a first plurality of company data elements, each respective one of the first plurality of company data elements comprising:
a geospatial coordinate within the first geospatial boundary;
a company attribute; and
a second classification code that is substantially similar to the first classification code;
determining a number of company data elements that comprise the first plurality of company data elements;
comparing the number of company data elements to a threshold;
generating an aggregation of company attributes; and
providing the aggregation of company attributes to a user via a user device.

2. The method of claim 1, further comprises generating a second geospatial boundary at a second distance from the base geospatial coordinate that is greater than the first distance.

3. The method of claim 2, further comprising generating a second plurality of company data elements, each respective one of the second plurality of company data elements comprising:
a geospatial coordinate within the second geospatial boundary and outside of the first geospatial boundary;
a company attribute; and
a third classification code that is substantially similar to the first classification code.

4. The method of claim 3, further comprising determining that the number of company data elements comprising the first plurality of company data elements and second plurality of company data elements exceeds the threshold.

5. The method of claim 4, wherein the first distance comprises a first radius comprising the base geospatial coordinate as a center of the first radius, and the second distance comprises a second radius comprising the base geospatial coordinate as a center of the second radius.

6. The method of claim 4, wherein providing the aggregation of company attributes to a user comprises displaying a statistical metric of the company attributes in a visual format and a confidence interval for the statistical metric of the company attributes.

7. The method of claim 4, wherein the company attribute of the first plurality of company data elements and second plurality of company data elements are within a range of company attribute values.

8. A system comprising:
a memory comprising computer-readable instructions;
a processor configured to execute the computer-readable instructions and cause the system to:
receive a first classification code and a base geospatial coordinate for a first company;
generate a first geospatial boundary at a first distance from the base geospatial coordinate, the base geospatial coordinate being within the first geospatial boundary;
generate a first plurality of company data elements, each respective one of the first plurality of company data elements comprising:
a geospatial coordinate within the first geospatial boundary;
a company attribute; and
a second classification code that is substantially equal to the first classification code;
determine a number of company data elements that comprise the first plurality of company data elements;
compare the number of company data elements to a threshold;
generating an aggregate of company attributes; and
provide the aggregate of company attributes to a user via a user device.

9. The system of claim 8, wherein the computer-readable instructions further cause the system to generate a second geospatial boundary at a second distance from the base geospatial coordinate that is greater than the first distance responsive to a determination that the number of company data elements does not exceed the threshold.

10. The system of claim 9, wherein the computer-readable instructions further cause the system to generate a second plurality of company data elements, each respective one of the second plurality of company data elements comprising:
a geospatial coordinate within the second geospatial boundary;
a company attribute; and
a third classification code that is substantially similar to the first classification code.

11. The system of claim 10, wherein the computer-readable instructions further cause the system to determine that the number of company data elements comprised of the first plurality of company data elements and the second plurality of company data elements exceeds the threshold.

12. The system of claim 11, wherein the first distance comprises a first radius comprising the base geospatial coordinate as a center of the first radius, and the second distance comprises a second radius comprising the base geospatial coordinate as a center of the second radius.

13. The system of claim 12, wherein the computer-readable instructions to provide the aggregate of company attributes to a user further cause the system to display a statistical metric of the company attributes in a visual format and a confidence interval for the statistical metric of the company attributes.

14. The system of claim 11, wherein the company attribute of the first plurality of company data elements and the second plurality of company data elements are within a range of company attribute values.

15. A method, comprising:
receiving a first company attribute in a first range;
receiving a first company classification code;
receiving a first company geospatial coordinate;
receiving, a plurality of second company data structures, each of the second company data structures comprising a second company geospatial coordinate and a second company attribute;
determining, a plurality of third company data structures based on the second company geospatial coordinate of each of the plurality of second company data structures, the plurality of third company data structures being a subset of the second company data structures; and
displaying an aggregated value comprising the second company attribute of each of the plurality of third company data structures on a user device.

16. The method of claim 15, wherein the second company geospatial coordinate of each of the third company data structures is within a first boundary defined by the first company geospatial coordinate.

17. The method of claim 16, wherein the first boundary is a first radius having the first company geospatial coordinate at a center of the first radius.

18. The method of claim 16, further comprising determining that the second company attribute of the plurality of third company data structures is below a threshold.

19. The method of claim 18, further comprising determining, a plurality of fourth company data structures being a subset of the plurality of third company data structures based on a second radius of the first company geospatial coordinate.

20. The method of claim 19, wherein displaying the aggregated value further comprises displaying an aggregated value comprising a fourth company attribute of each of the plurality of fourth company data structures.
